(19) United States
(12) Patent Application Publication
(10) Pub. No.: US 2019/0242702 A1
(43) Pub. Date: Aug. 8, 2019

(54) Method and Apparatus for Measuring Surface Finish of a Workpiece

(71) Applicant: Hexagon Metrology, Inc., North Kingstown, RI (US)

(72) Inventors: Gurpreet Singh, Providence, RI (US); Jürgen Schneider, Wetzlar (DE)

(21) Appl. No.: 15/887,514

(22) Filed: Feb. 2, 2018

(51) Int. Cl. G01B 11/30; G01B 11/00; G01B 5/28; G01B 5/008

(52) U.S. Cl. CPC G01B 11/303; G01B 5/008; G01B 5/28; G01B 11/005

(57) ABSTRACT

A coordinate measuring machine measures surface finish of a workpiece, without requiring special sensors or a high-precision physical reference datum. To that end, the coordinate measuring machine measures a plurality of points on the surface of the workpiece, and processes the measurements to produce a surface finish spectrum, which is a subset of frequencies that define the spatial spectrum of the surface.

### TECHNICAL FIELD

The present disclosure relates to coordinate measuring machines and, more particularly, to coordinate measuring machines that measure surface finish.

### BACKGROUND ART

Coordinate measuring machines (CMMs) are used for accurately measuring a wide variety of work pieces. For example, CMMs can measure critical dimensions of aircraft engine components, surgical tools, and gun barrels. Precise and accurate measurements help to ensure that their underlying systems, such as an aircraft in the case of aircraft components, operate as specified. Measurement of surface finish, on the other hand, has historically been beyond the ability of CMMs, and required specialized tools.

### SUMMARY OF VARIOUS EMBODIMENTS

In accordance with one embodiment described herein, a method of assessing, with a coordinate measuring machine, a surface finish of a workpiece having an expected geometry, includes measuring, with a probe of a coordinate measuring machine, a plurality of points on a surface of the workpiece, the plurality of points characterized by a spatial spectrum. The probe may be a tactile probe, an optical probe, a capacitive probe, an inductive probe, or a resistive probe, as such probes are known in the art, to name but a few examples. In some embodiments, the plurality of points are evenly-spaced points.

The method also includes retrieving or receiving, from a computer memory, a cutoff frequency. In some embodiments, the cutoff frequency is equal to or greater than the maximum spatial frequency of the expected geometry.

Moreover, in some embodiments, the expected geometry is characterized by a maximum expected geometry spatial frequency, and the workpiece also has a surface waviness characterized by a maximum waviness frequency. In such embodiments, the cutoff frequency is above the greater of the maximum expected geometry spatial frequency and the maximum waviness frequency.

In addition, the method includes characterizing the surface finish of the workpiece by removing, from the spatial spectrum, all frequencies below the cutoff frequency to produce a surface finish spectrum. In some embodiments, characterizing the surface finish of the workpiece further includes comparing the surface finish spectrum to a specification for the workpiece, to determine whether the surface finish is within a specified tolerance.

Moreover, some embodiments also include measuring dimensions of the workpiece with the probe, the probe being the same probe used to measure for surface roughness. Consequently, embodiments of the method do not require a specialized or different probe for measuring both surface roughness and other features of the workpiece, since a single probe can be used for both.

In another embodiment, a system for assessing a surface finish of a workpiece having an expected geometry includes a coordinate measuring machine configured to control a probe to measure a plurality of points on a surface of the workpiece. The system also includes a computer configured to receive measurements obtained by the probe; receive a cutoff frequency; and process the measurements to produce a surface finish spectrum, the surface finish spectrum limited to frequencies above the cutoff frequency.

Another embodiment includes a non-transient computer programmed product bearing non-transient executable computer code. The executable computer code includes code for controlling a probe of a coordinate measuring machine to measure a plurality of points on a surface of the workpiece, the plurality of points characterized by a spatial spectrum; code for retrieving, from a computer memory, a cutoff frequency; and code for characterizing the surface finish of the workpiece by removing, from the spatial spectrum, all frequencies below the cutoff frequency to produce a surface finish spectrum.

### BRIEF DESCRIPTION OF THE DRAWINGS

The foregoing features of embodiments will be more readily understood by reference to the following detailed description, taken with reference to the accompanying drawings, in which:

FIGS. 1A-1D schematically illustrate an embodiment of a CMM;

FIGS. 1E-1H schematically illustrate features of a workpiece;

FIG. 2A schematically illustrates a prior art system for measuring surface finish;

FIG. 2B-2H schematically illustrate features of illustrative workpieces;

FIG. 3 is a flowchart of a method for determining surface finish of a workpiece;

FIGS. 4A-4C schematically illustrate measuring a plurality of points on a workpiece;

FIGS. 4D-4G schematically illustrate filtering a spectrum.

### DETAILED DESCRIPTION OF SPECIFIC EMBODIMENTS

Illustrative embodiments described below enable a coordinate measuring machine to measure the surface finish of a workpiece using the same measuring features used to measure the workpiece, without requiring a high-precision physical datum and probes of prior art surface finish measuring systems.

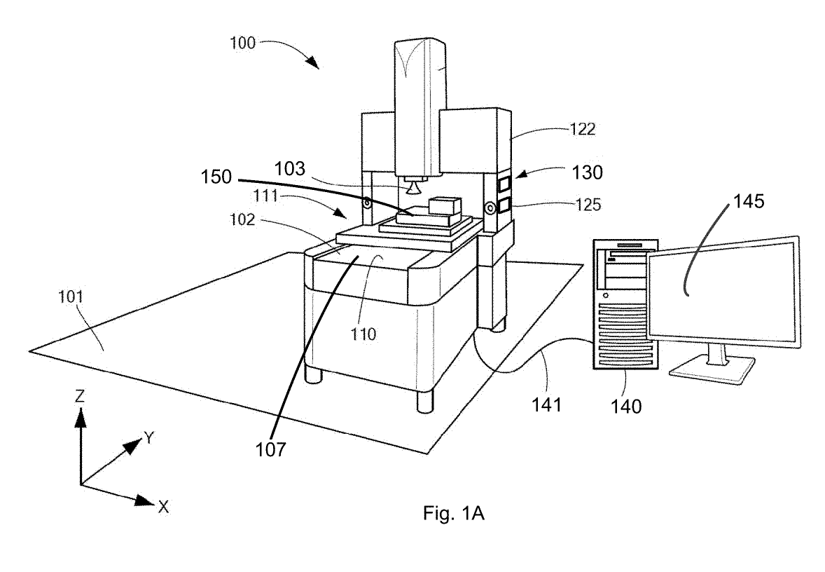

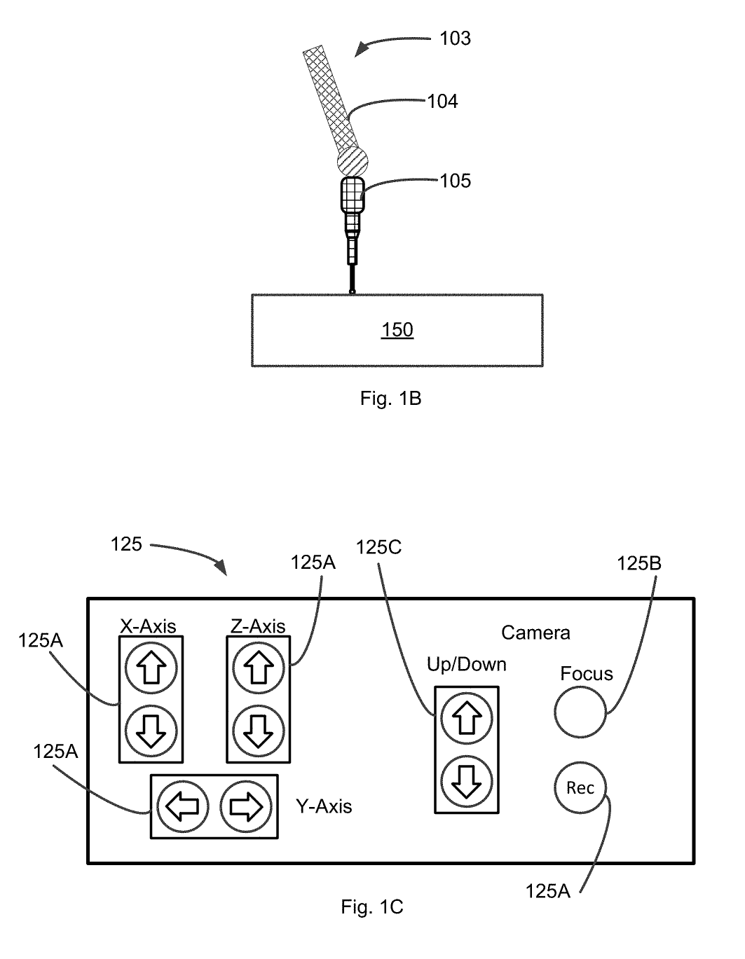

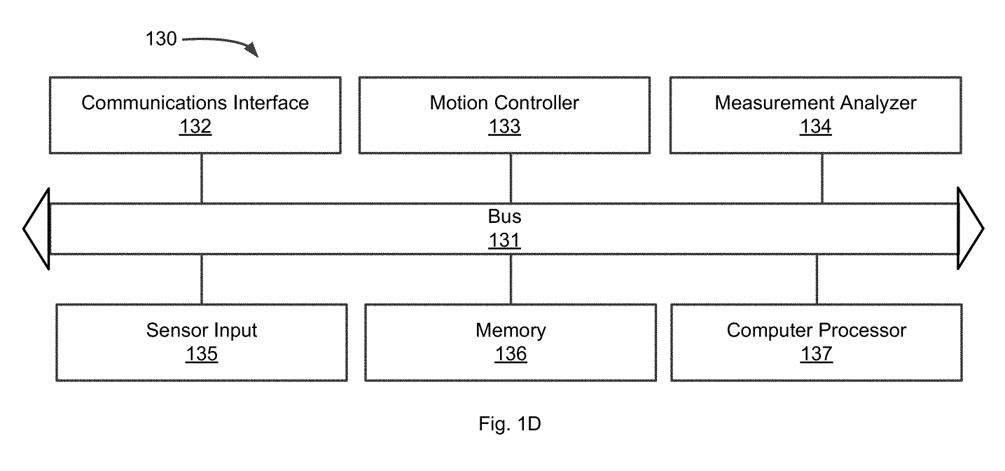

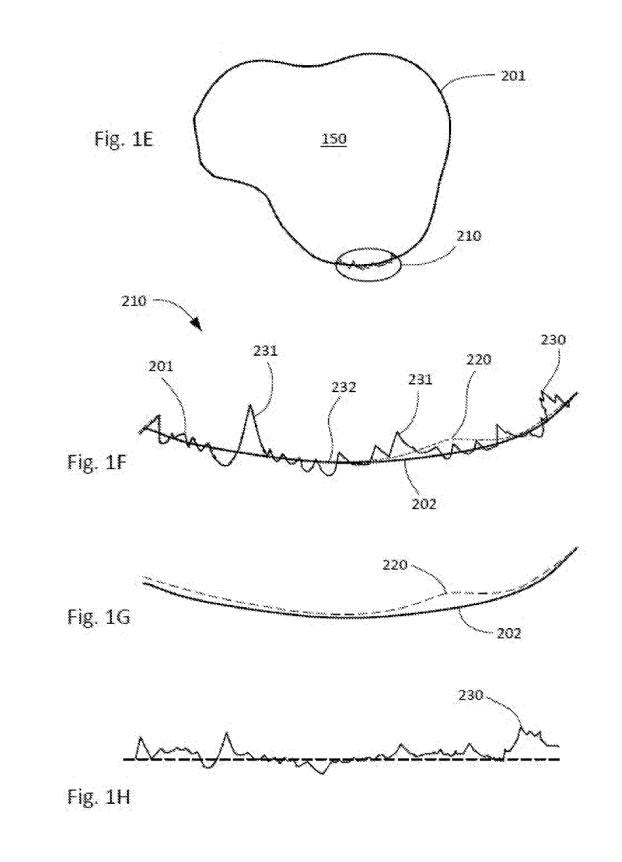

FIG. 1A shows one type of coordinate measurement machine 100 (hereinafter “CMM 100”) that may be configured in accordance with illustrative embodiments. As known by those in the art, the CMM 100, which is supported on a floor 101 in this figure, measures an object or workpiece 150 on its bed/table/base (referred to as “base 102”). Generally, the base 102 of the CMM 100 defines an X-Y plane 110 that typically is parallel to the plane of the floor 101.

To measure an object within a measuring space 111 on its base 102, the CMM 100 has movable features 122 arranged to move a measuring device 103, such as a stylus 105 coupled with a movable arm 104. Alternatively, some embodiments move the base 102 (e.g., or a portion of the base 102, such as a moveable table 107) with respect to a stationary measuring device 103. Either way, the movable features 122 of the CMM 100 manipulate the relative positions of the measuring device 103 and the object with respect to one another to obtain the desired measurement. Accordingly, the CMM 100 can measure the location of a variety of features of the object or artifact.

Some embodiments of a CMM 100 include a control system 130 (or “controller” or “control logic”) configured to control the CMM 100, and process data acquired by the CMM. FIG. 1D schematically illustrates an embodiment of a control system 130 having several modules in electronic communication over a bus 131.

In general, some or all of the modules may be implemented in one or more integrated circuits, such as an ASIC, a gate array, a microcontroller, or a custom circuit, and at least some of the modules may be implemented in non-transient computer-implemented code capable of being executed on a computer processor 137.

Some embodiments include a computer processor 137, which may be a microprocessor as available from Intel Corporation, or an implementation of a processor core, such as an ARM core, to name but a few examples. The computer processor 137 may have on-board, non-transient digital memory (e.g., RAM or ROM) for storing data and/or computer code, including non-transient instructions for implementing some or all of the control system operations and methods. Alternatively, or in addition, the computer processor 137 may be operably coupled to other non-transient digital memory, such as RAM or ROM, or a programmable non-transient memory circuit for storing such computer code and/or control data. Consequently, some or all of the functions of the controller 130 may be implemented in software configured to execute on the computer processor.

The control system 130 includes a communications interface 132 configured to communicate with other parts of the CMM 100, or with external devices, such as computer 140 via link 141. To that end, communications interface 132 may include various communications interfaces, such as an Ethernet connection, a USB port, or a Firewire port, to name but a few examples.

The control system 130 also includes a sensor input 135 operably coupled to one or more sensors, such as a measuring device 103. The sensor input 135 is configured to receive electronic signals from sensors, and in some embodiments to digitize such signals, using a digital to analog (“D/A”) converter. The sensor input 135 is coupled to other modules of the control system 130 to provide to such other modules the (digitized) signals received from sensors.

The motion controller 133 is configured to cause motion of one or more of the movable features of the CMM 100. For example, under control of the computer processor 137, the motion controller 133 may send electrical control signals to one or more motors within the CMM 100 to cause a movable features of the CMM 100 to move a measuring sensor 103 to various points within the measuring space 111 and take measurements of the workpiece 150 at such points. The motion controller 133 may control such motion in response to a measurement program stored in memory module 136, or stored in computer 140, or in response to manual control by an operator using manual controller 125, to name but a few examples.

Measurements taken by the CMM 100 may be stored in a memory module 136, which includes a non-transient memory. The memory module 136 is also configured to store, for example, a specification for a workpiece 150 to be measured; a specification for a calibration artifact; an error map; and non-transient instructions executable on the computer processor 137, to name but a few examples. Such instructions may include, among other things, instructions for controlling the moveable features of the CMM 100 for measuring a workpiece 150 and/or a calibration artifact; instructions for analyzing measurement data; and instructions for correcting measurement data (e.g., with an error map).

The measurement analyzer 134 is configured to process measurement data received from one or more sensors, such as measuring sensor 103. In some embodiments, the measurement analyzer 134 may revise the measurement data, for example by modifying the measurement data using an error map, and/or compare the measurement data to a specification, for example to assess deviation between a workpiece 150 and a specification for that workpiece 150. To that end, the measurement analyzer 134 may be a programmed digital signal processor integrated circuit, as known in the art.

Alternatively, or in addition, some embodiments couple the CMM 100 with an external computer (or “host computer”) 140. In a manner similar to the control system 130, the host computer 140 has a computer processor such as those described above, and non-transient computer memory in communication with the processor of the CMM 100, and a display screen 145. The non-transient memory is configured to hold non-transient computer instructions capable of being executed by the processor of the computer 140, and/or to store non-transient data, such as data acquired as a result of the measurements of an object on the base 102.

Among other things, the host computer 140 may be a desktop computer, a tower computer, or a laptop computer, such as those available from Dell Inc., or even a tablet computer, such as the iPad™ available from Apple Inc. The host computer 140 may be coupled to the CMM 100 via a hardwired connection, such as an Ethernet cable 141, or via a wireless link, such as a Bluetooth link or a Wi-Fi link. The host computer 140 may, for example, include software to control the CMM 100 during use or calibration, and/or may include software configured to process data acquired during operation of the CMM 100. In addition, the host computer 140 may include a user interface configured to allow a user to manually operate the CMM 100.

Because their relative positions are determined by the action of the movable features 122, the CMM 100 may be considered as having knowledge of the relative locations of the base 102, and the object 150, with respect to its measuring device 103. More particularly, the computer processor 137 and/or computer 140 control and store information about the motions of the movable features 122. Alternately, or in addition, the movable features 122 of some embodiments include sensors that sense the locations of the table 107 and/or measuring device 103, and report that data to the computers 137 or 140. The information about the motion and positions of the table and/or measuring device 103 of the CMM 100 may be recorded in terms of a one-dimensional (e.g., X, Y, or Z), a two-dimensional (e.g., X-Y; X-Z; Y-Z) or three-dimensional (X-Y-Z) coordinate system referenced to a point on the CMM 100.

Some CMMs also include a manual user interface 125, such as that shown generically in FIG. 1A and as further schematically illustrated in FIG. 1C. As shown, the manual user interface 125 may have control buttons 125A and knobs 125B that allow a user to manually operate the CMM 100. Among other things, the interface 125 may enable the user to change the position of the measuring device 103 or base 102 (e.g., with respect to one another) and to record data describing the position of the measuring device 103 or base 102.

In a moving table CMM, for example, the measuring device 103 may also be movable via control buttons 125C. As such, the movable features 122 may respond to manual control, or be under control of the computer processor 137, to move the base 102 and/or the measuring device 103 relative to one another. Accordingly, this arrangement permits the object being measured to be presented to the measuring device 103 from a variety of angles, and in a variety of positions.

Features of a Workpiece

Generally, an object 150 to be measured (e.g., a “workpiece”) has a pre-defined, specified shape with pre-defined, specified dimensions (together, the object's “expected geometry”). In practice, however, a workpiece 150 typically varies from that ideal shape. For example, a manufacturing error may result in a misshapen workpiece 150 that fails to meet its specification.

For purposes of illustration, FIG. 1E schematically illustrates an embodiment of a workpiece 150 having a surface 201. A portion 210 of the surface 201 of the workpiece 150 is schematically enlarged in FIG. 1F.

Variations in the manufacturing process may result in a deviation from the expected geometry, which may be known as surface waviness 220. As an example, the dashed line in FIG. 1F represents the waviness 220 of the surface 201 of the workpiece 150, and the solid line represents the specified surface 202 (part of the expected geometry). The jagged line 230 represents surface finish, as described further below.

The dashed line of FIG. 1G schematically illustrates the waviness 220 of the surface 201, showing variations from the specified surface 202. In some cases, waviness 220 causes the workpiece 150 to fail to meet its specification. In other cases, however, the workpiece 150 may still meet its specification even with some waviness.

Some workpieces also have a specified surface finish 230 (e.g., roughness or smoothness of the workpiece surface 201), the features of which typically have smaller dimensions (e.g., height and width) than manufacturing variations and surface waviness. FIG. 1F schematically illustrates the surface finish 230 within area 210 of the workpiece 150, and includes peaks 231 and valleys 232. FIG. 1H schematically illustrates the surface finish 230 of the surface 201, isolated from the surface 201 itself.

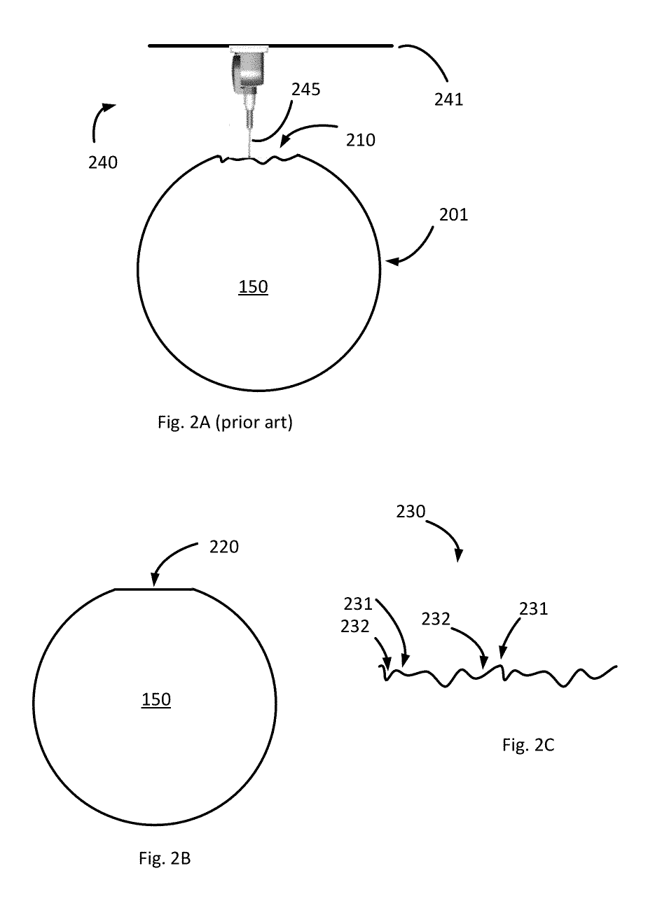

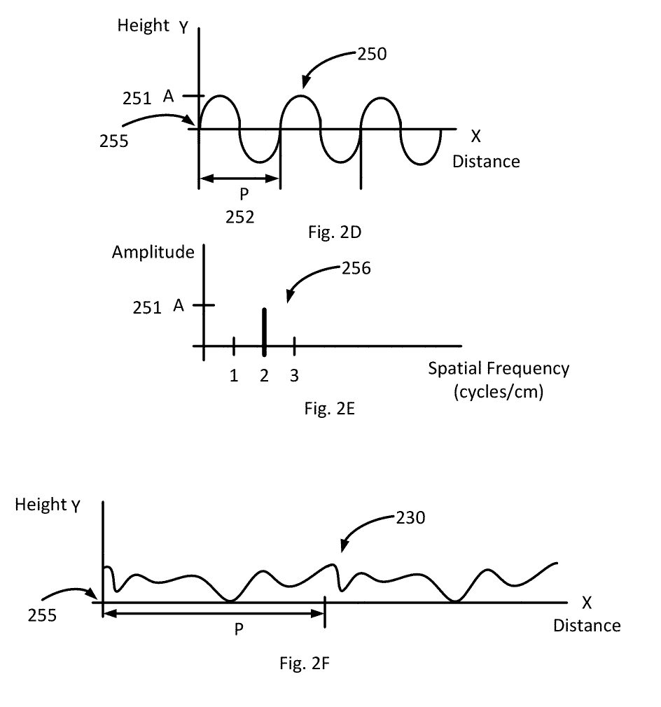

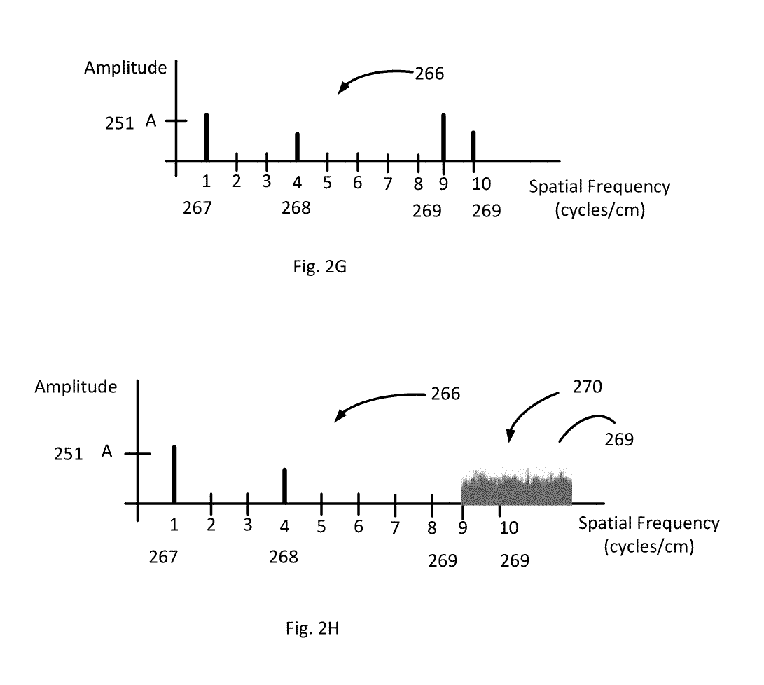

The surface finish 230 of a workpiece 150 may be a specified feature designed into the workpiece 150. For example, if the workpiece 150 of FIG. 2A is a grinding wheel, then its specification will require a minimum and/or maximum roughness to the surface finish 230 on its surface 201. Other workpieces may specify only a maximum surface finish 230. For example, if the workpiece 150 is a ball bearing, its specification may require a relatively smooth surface finish.

The surface finish 230 of the surface 201 may be stochastic, but some workpieces also have a surface finish 230 that includes features that are periodic across positions in space, for example as in FIG. 2D. The inventors have realized that such a surface finish 230, whether periodic or stochastic, may be characterized by its spatial frequency spectrum. For example, a spectrum of the frequency and amplitude of a stochastic surface is schematically illustrated in FIG. 2H, and may be described as having a spectrum 270 similar to that of noise.

System for Measuring Surface Finish

FIG. 2A schematically illustrates a prior art system 240 for measuring surface finish of a workpiece 150. The workpiece 150 of FIG. 2A is further schematically illustrated in FIG. 2B and FIG. 2C.

An example of a surface 250 is provided in FIG. 2D, in which surface 250 is periodic (in this example, sinusoidal), with amplitude A 251 shown in the Y-axis, and period P 252 indicated along its position along the X-axis. The height (H) of the surface 250 at a point (D) in along the distance may be described as follows:

H=A sin 2πD/P

where:

A is the amplitude;

The symbol “π” is the mathematical constant “pi;”

D is the distance from the origin 255;

P is the period, measured in distance.

If the amplitude (A) is 5 mm, and the period (P) is 0.5 centimeters, then the height (H) of the surface 250 at a point (D) in centimeters from the origin 255 may be described as follows:

H=5 sin 2πD/0.5

In this example, if D=0.125 centimeters from the origin 255, the height (H) of surface 250 is:

H=5 sin 2π(0.125/0.5)=5 sin 2π(0.25)=5 sin π/2=5 mm.

Similarly, if D=0.327 centimeters from the origin 255, the height (H) of surface 250 is:

H=5 sin 2π(0.375/0.5)=5 sin 2π(3/4)=−5 mm.

Spatial frequency is a characteristic of a physical surface that is periodic across position in space. Spatial frequency is not a function of time. The surface 250 may be said to have a frequency of 2 cycles/centimeter.

The system 240 includes a datum 241 (which may be referred to as a “physical reference datum”), and a stylus 245 coupled to the datum 241. The stylus 245 touches points on the surface 201 of the workpiece 150 to produce a set of surface measurements, relative to the datum 241. In order to obtain measurements sufficient for assessing surface finish 230, the datum 241 must be straight and rigid to a high degree of accuracy, and the stylus 245 must be able to move, relative to the datum 241, with a high degree of precision. Due to the required high-precision, the measuring features of coordinate measuring machines have historically been unable to measure surface finish. Illustrative embodiments described herein enable assessment of the surface finish 230 of a workpiece by a CMM 100 without the high-precision datum 241. Moreover, in view of the fact that illustrative embodiments do not require and do not have a datum, they enable assessment of the surface finish 230 of a workpiece by a CMM 100 without the previously-required ability to move a stylus 245 with the high degree of precision relative to such a datum 241.

FIG. 2E schematically illustrates the spectrum 256 of surface 250, which may be referred-to as the spatial spectrum of the surface 250.

FIG. 2F schematically illustrates a surface 230 that is more complex than surface 250, but which nevertheless can be approximated as a summation of periodic frequencies. Consequently, the surface 230 may be represented in part by the frequencies of its periodic components. In this example, FIG. 2G schematically illustrates the spatial spectrum 266 of the surface 230, and shows that surface 230 has a low-frequency periodic component 267 at 1 cycle/centimeter, a smaller-amplitude mid-frequency component 268 at 4 cycles/centimeter, and high-frequency components 269 at 9 cycles/centimeter and 10 cycles/centimeter. In general, higher spatial frequencies (e.g., 269) represent surface finish 230, lower spatial frequencies (e.g., 267) represent the expected geometry of the surface 201, and intermediate frequencies (e.g., 268) represent waviness 220. In this example, the prefixes “low,” “lower,” “medium,” “intermediate,” “high” and “higher” are intended only to distinguish the components from one another.

In this example, the low-frequency component 267 (shown in FIG. 2G and FIG. 2H) is due to the curvature of surface 201. If the low-frequency component 267 is the highest spatial frequency attributable to the expected geometry of the workpiece 150, it may be referred to as the maximum spatial frequency of the expected geometry. It should be noted that some components of a surface 201 may be periodic (e.g., 267 and 268 in FIG. 2H) even though other components (e.g., 270 in FIG. 2H) may be stochastic.

Also in this example, the mid-frequency component 268 is due to the waviness 220 of the surface 201. The high-frequency components 269 are due to the surface finish 230. If the mid-frequency component 268 is the highest spatial frequency attributable to the waviness of the workpiece 150, it may be referred to as the maximum waviness frequency of the expected geometry.

Although traditional coordinate measuring machines 100 are capable of detecting large features that cause a workpiece to fail to meet its specification, as well as waviness, they are not suited for (or capable of) measuring surface finish 230. Instead, prior art systems for measuring surface finish typically require specialized, dedicated high-precision hardware.

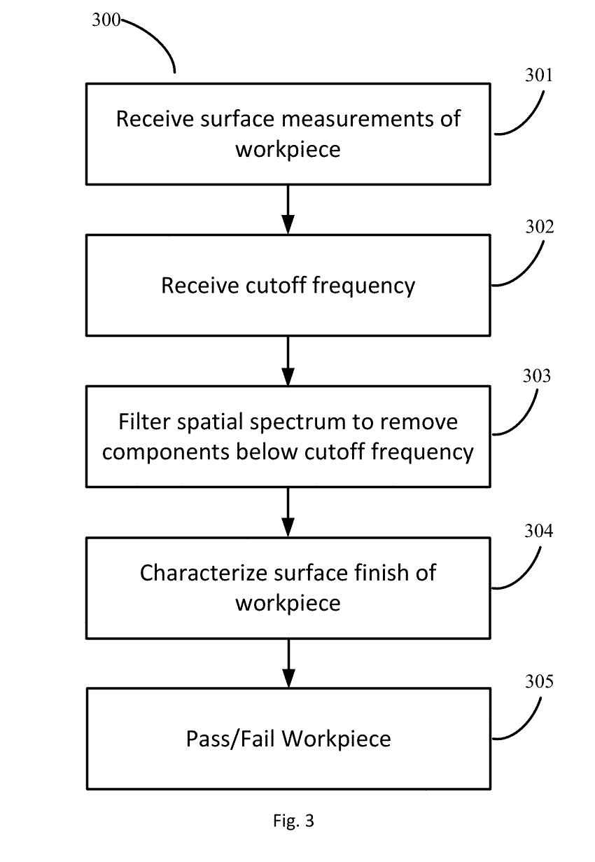

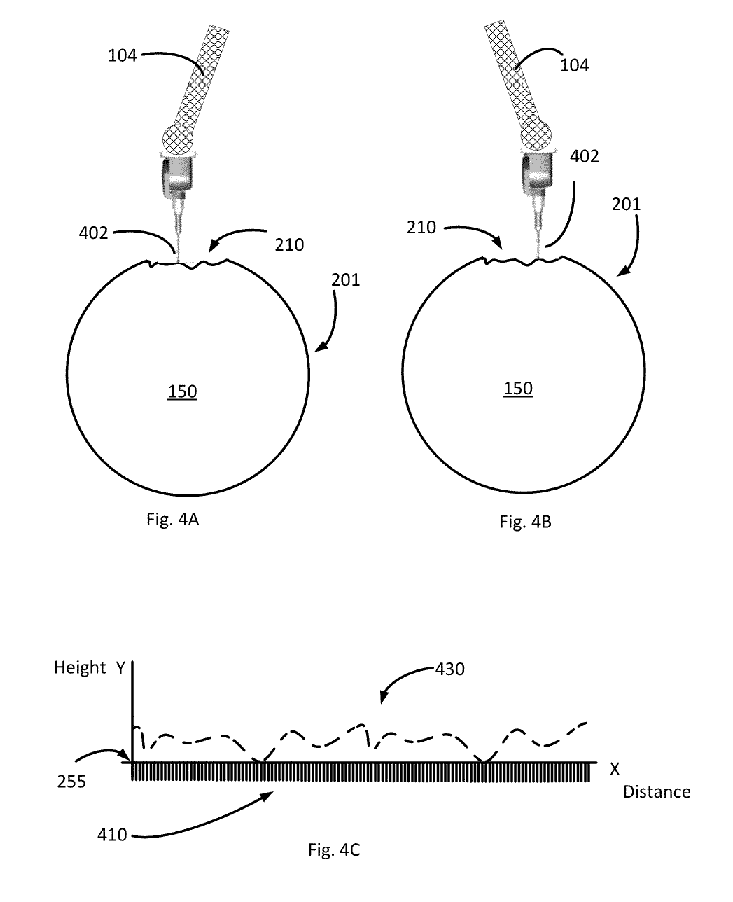

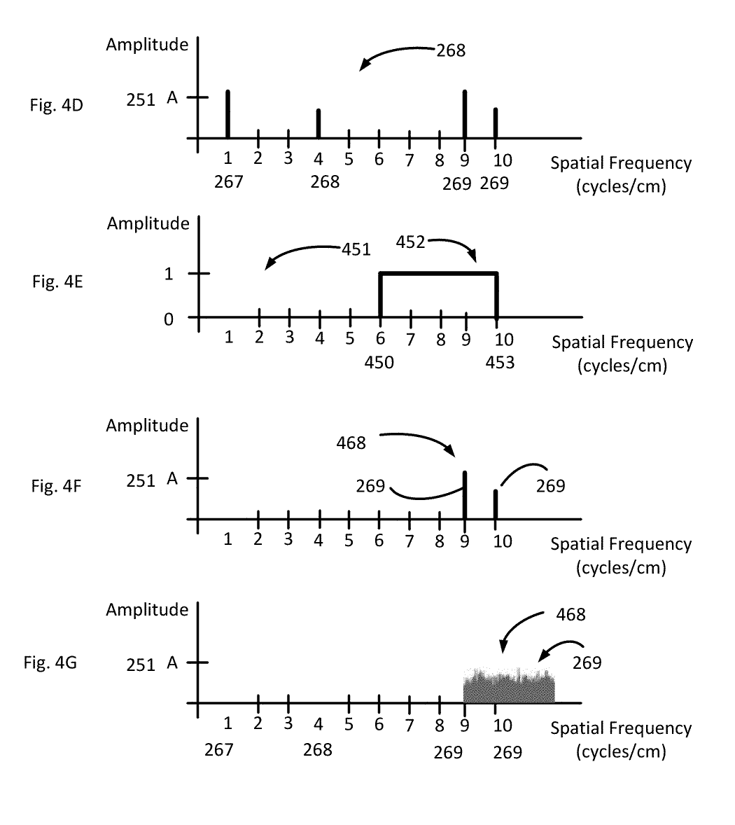

FIG. 3 is a flow chart that illustrates a method 300 of determining the surface frequency of a workpiece with a coordinate measuring machine, or a dedicated surface measuring instrument, and FIG. 4A and FIG. 4B schematically illustrate a coordinate measuring machine 100 in the process of measuring surface finish 230 of the workpiece 150, and FIGS. 4C, 4D, and 4E schematically illustrate inputs and outputs at steps from the method 300. It should be noted that this method 300 is simplified from a longer process that may be used to determine the surface frequency of a workpiece. Accordingly, the method 300 may have many steps that those skilled in the art likely would use. In addition, some of the steps may be performed in a different order than that shown, or at the same time. Those skilled in the art therefore can modify the process as appropriate.

At step 301, a computer, such a computer in the controller 130 for example, receives surface measurements of the workpiece 150 measured by a coordinate measuring machine 100. For example, receiving such surface measurements may be accomplished by controlling the arm 104 of the CMM 100 to measure the locations of several points 410 along the surface 201 of the workpiece using the probe 402. The probe 402 may be a tactile stylus that touches the points 410 on the workpiece 150, or an optical probe, for example.

The several points 410 may be equally-spaced. In some embodiments, however, the workpiece 150 may be measured by dragging the probe 402 continuously across the workpiece surface 201 to produce a continuous measurement or stream of measurements. If measurements of equally-spaced points are not available, some embodiments may produce equally-spaced measurements by interpolating between available measurements, or selecting equally-spaced points from a continuous measurement. Alternatively, if measurements of equally-spaced points are not available, some embodiments may perform the process 300 using techniques known in the art of digital signal processing for working with non-uniform sample sequences, such as non-uniform discrete Fourier transforms, and digital filters such as the FIR filter.

Each measurement produces a data point, and the measurements, collectively, produce a set of data points 430, as schematically illustrated in FIG. 4C. In preferred embodiments, to avoid aliasing, the spacing between the equally-spaced points 410 defines a spatial frequency that is at least twice the spatial the frequency of highest-frequency component 269 the spatial frequency of the surface finish 230.

At step 302, a computer processor receives, from a computer memory, a cutoff frequency 450. The computer processor and computer memory may be part of the CMM 100 (e.g., computer 137; memory 136), or may be part of an off-board computer (for example, host computer 140).

Frequencies above the cutoff frequency 450 represent measurements of surface finish 230, and frequencies below the cutoff frequency 450 represent measurements of the expected geometry of the workpiece 150, and may include measurements of waviness 220 at the surface 201 of the workpiece 150. Preferably, the cutoff frequency 450 is lower than the lowest component of the surface finish 230, and above the highest frequency of the spectrum of the expected geometry, and waviness.

At step 303 a computer processor (e.g., 137; 140) processes the set of data points to filter out frequencies below the cutoff frequency 450, and thereby produces a surface finish spectrum 468 limited to frequencies above the cutoff frequency 450, as schematically illustrated in FIGS. 4F and 4G. For example, the computer processor (e.g., 137; 140) may produce a spectrum of the data points 430 via a discrete Fourier transform (DFT) or a fast Fourier transform (FFT), and then removing or deleting all frequencies below the cutoff frequency 450. Alternatively, the computer processor (e.g., 137; 140) may implement a high-pass filter using methods known from the art of digital signal processing, in which the filter includes a reject band 451 below the cutoff frequency 450, and a pass band 452 above the cutoff frequency. In some embodiments, the pass band may be limited by an upper bound 453.

At step 304, the computer processor (137; 140) characterizes the surface finish 230 based on the surface finish spectrum 468. In one embodiment, the characterization of the surface finish 230 may be simply the surface finish spectrum 468 itself, or its peak amplitude, or average amplitude, to name but a few examples. In some embodiments, the characterization of the surface finish 230 includes comparing the surface finish spectrum 468 to a specification for the workpiece, to determine whether the surface finish is within a specified tolerance set forth in the specification. Such a tolerance may be specified as the spectrum's amplitude, peak amplitude, average amplitude, or spectral energy density, to name but a few examples.

In addition to measuring the surface finish 230 of the workpiece 150, in some embodiments the coordinate measuring machine 100 also measures other features of the workpiece 150, such as physical dimensions different from its surface finish. Measuring such other features may be done before determining the surface frequency of a workpiece, after determining the surface frequency of a workpiece (i.e., before or after the method 300), or even during the process of determining the surface frequency of a workpiece, such us during step 304.

Some embodiments also determine, and optionally indicate to a user (e.g., by displaying a result via computer screen 145), whether the workpiece 150 meets (passes) or fails to meet (fails) a specification, at step 305. The pass/fail determination may be based on a comparison of the characterization of the surface finish 230 to a specification for the workpiece 150 that specifies a minimum roughness, or a maximum roughness, or a range of acceptable roughness, and/or a comparison of measurements of other features of the workpiece 150 to a specification for the workpiece 150.

The following is a list of reference numbers used herein:
100: Coordinate measuring machine;
101: Floor;
102: Base;
103: Measuring device;
104: Arm;
105: Probe
107: Table;
110: X-Y plane;
111: Measurement space;
122: Movable features;
125: CMM user interface;
125A: Control buttons;
125B: Control knobs;
130: Control system;
131: Bus;
132: Communications interface;
133: Motion Controller;
134: Measurement analyzer;
135: Sensor input;
136: Memory;
137: Computer processor;
140: Host computer;
141: Cable;
145: Computer screen;
150: Workpiece;
201: Surface of workpiece;
202: Specified surface of workpiece;
210: Irregularity in workpiece;
220: Waviness;
230: Surface finish;
231: Peak;
232: Valley;
240: Datum-based system for measuring surface finish;
241: Datum;
245: Stylus;
250: Surface having a spatial frequency;
251: Amplitude of surface;
252: Period of surface;
255: Origin;
256: Spatial spectrum;
260: Complex periodic surface;
266: Spatial spectrum of complex surface;
267: Low-frequency component of spatial spectrum;
268: Mid-frequency component of spatial spectrum;
269: High-frequency component of spatial spectrum;
270: Spatial spectrum of a stochastic portion of surface finish;
402: Surface finish probe (e.g., stylus; optical probe);
430: Set of data points;
450: Cutoff frequency;
451: Reject band;
452: Pass band;
453: Upper boundary of pass band;
468: Surface finish spectrum.

Various embodiments of the present invention may be characterized by the potential claims listed in the paragraphs following this paragraph (and before the actual claims provided at the end of this application). These potential claims form a part of the written description of this application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public.

Without limitation, potential subject matter that may be claimed (prefaced with the letter “P” so as to avoid confusion with the actual claims presented below) includes:

P1. A system for assessing a surface finish of a workpiece having an expected geometry, the system including: means for measuring a plurality of points on a surface of the workpiece; and computing means for: receiving measurements obtained by the means for measuring; receiving a cutoff frequency; and processing the measurements to produce a surface finish spectrum, the surface finish spectrum limited to frequencies above the cutoff frequency.

P2. The system of P1, wherein the plurality of points are evenly-spaced points.

P3. The system of P1, wherein the cutoff frequency is the maximum spatial frequency of the expected geometry.

P4. The system of P1 wherein the means for measuring comprises a tactile stylus.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods may be implemented as a computer program product for use with a computer system. Such implementation may include a series of computer instructions fixed on a tangible medium, such as a non-transient computer readable medium (e.g., a diskette, CD-ROM, ROM, FLASH memory, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A coordinate measuring machine system for assessing a surface finish of a workpiece having a surface and an expected geometry, the system comprising:
a coordinate measuring machine configured to control a probe to measure a plurality of points on the surface of the workpiece, thereby producing a plurality of measurements; and
a computer configured to:
receive the plurality of measurements obtained by the probe;
receive a cutoff frequency; and
process the plurality of measurements to produce a surface finish spectrum, the surface finish spectrum limited to frequencies above the cutoff frequency.

2. The system of claim 1, wherein the plurality of points are evenly-spaced points.

3. The system of claim 1, wherein the expected geometry has a maximum spatial frequency, and the cutoff frequency is equal to or greater than the maximum spatial frequency.

4. The system of claim 1, wherein the probe comprises a tactile stylus.

5. The system of claim 1, wherein the probe comprises an optical probe.

6. The system of claim 1, wherein the computer is further configured to compare the surface finish spectrum to a specification for the workpiece, to determine whether the surface finish is within a tolerance set forth in the specification.

7. The system of claim 1, wherein the computer is further configured to measure dimensions of the workpiece with the probe.

8. The system of claim 1, wherein:
the expected geometry is characterized by a maximum expected geometry spatial frequency;
the workpiece also has a surface waviness characterized by a maximum waviness frequency; and
the cutoff frequency is above the greater of the maximum expected geometry spatial frequency and the maximum waviness frequency.

9. A method of assessing, with a coordinate measuring machine, a surface finish of a workpiece, the method comprising:
measuring, with a probe of a coordinate measuring machine, a plurality of points on a surface of the workpiece, the plurality of points characterized by a spatial spectrum;
retrieving, from a computer memory, a cutoff frequency; and
characterizing the surface finish of the workpiece by removing, from the spatial spectrum, all frequencies below the cutoff frequency to produce a surface finish spectrum.

10. The method of claim 9, wherein the plurality of points are evenly-spaced points.

11. The method of claim 9, wherein the workpiece has an expected geometry, and the expected geometry has a maximum spatial frequency, and the cutoff frequency is the maximum spatial frequency.

12. The method of claim 11, wherein:
the expected geometry is characterized by a maximum expected geometry spatial frequency;
the workpiece also has a surface waviness characterized by a maximum waviness frequency; and
the cutoff frequency is above the greater of the maximum expected geometry spatial frequency and the maximum waviness frequency.

13. The method of claim 9, wherein the probe comprises a tactile stylus, and wherein the coordinate measuring machine assesses the surface finish of the workpiece without a physical reference datum.

14. The method of claim 9, wherein the probe comprises an optical probe.

15. The method of claim 9, wherein characterizing the surface finish of the workpiece further includes comparing the surface finish spectrum to a specification for the workpiece, to determine whether the surface finish is within a tolerance set forth in the specification.

16. The method of claim 9, further comprising measuring dimensions of the workpiece with the probe.

17. A non-transient computer programmed product bearing non-transient executable computer code, the executable computer code comprising:
code for controlling a probe of a coordinate measuring machine to measure a plurality of points on a surface of a workpiece, the plurality of points characterized by a spatial spectrum;
code for receiving, from a computer memory, a cutoff frequency; and
code for characterizing the surface finish of the workpiece by removing, from the spatial spectrum, all frequencies below the cutoff frequency to produce a surface finish spectrum.

18. The non-transient computer programmed product of claim 17, wherein the plurality of points are evenly-spaced points.

19. The non-transient computer programmed product of claim 17, wherein the workpiece has an expected geometry, and the expected geometry has a maximum spatial frequency, and the cutoff frequency is equal to or greater than the maximum spatial frequency.

20. The non-transient computer programmed product of claim 17, wherein:
the workpiece has an expected geometry characterized by maximum expected geometry spatial frequency;
the workpiece also has a surface waviness characterized by a maximum waviness frequency; and
the cutoff frequency is above the greater of the maximum expected geometry spatial frequency and the maximum waviness frequency.
